(19) United States
(12) Patent Application Publication
(10) Pub. No.: US 2018/0275393 A1
(43) Pub. Date: Sep. 27, 2018

(54) Ocular Structure for Observation Apparatus

(71) Applicants: Sintai Optical (Shenzhen) Co., Ltd., ShenZhen City (CN); Asia Optical Co., Inc., Taichung (TW)

(72) Inventors: Sheng Luo, ShenZhen City (CN); Jia-Jun Cao, ShenZhen City (CN); Hua-Tang Liu, Taichung (TW); Yue-Ye Chen, ShenZhen City (CN); Yu-Rong Guan, ShenZhen City (CN); Ke-Yu Qiu, ShenZhen City (CN); Chiau-Jen Wang, Taichung (TW); Lian Zhao, ShenZhen City (CN)

(21) Appl. No.: 15/859,833

(22) Filed: Jan. 2, 2018

(30) Foreign Application Priority Data
Mar. 27, 2017 (CN) 201710189110.0

(51) Int. Cl. G02B 25/00

(52) U.S. Cl. CPC G02B 25/001

(57) ABSTRACT

An ocular structure for observation apparatus includes a first member, a second member and a main body. The first member includes at least one slot and a plurality of first limiting mechanisms. The second member includes at least one slider extending into the slot and a plurality of second limiting mechanisms. The main body includes an ocular lens unit, wherein the first member and the second member are mounted on the main body. The slider is moved in the slot when the first member and the second member are in relative rotation, and the first limiting mechanisms directly or indirectly match the second limiting mechanisms to position the first member with respect to the second member.

### BACKGROUND OF THE INVENTION

### Field of the Invention

The invention relates to an ocular structure for observation apparatus, and more particularly to an ocular structure including an outer ring capable of moving axially and being positioned in different positions.

### Description of the Related Art

A conventional observation apparatus (e.g. rangefinder, binocular telescope or monocular telescope) includes an ocular structure which is provided with an eyecup. In operation, the eyecup that is made of rubber can be turned out to adjust a distance between user's eyes and an ocular lens unit. Specifically, the distance is shortened after the eyecup is turned out. However, the eyecup in such a design has a short lifespan due to frequent turning operation. Therefore, the eyecup is required to be made of durable material.

### BRIEF SUMMARY OF THE INVENTION

The invention provides an ocular structure for observation apparatus capable of moving an outer ring relative to a main body through means similar to mated threads, so as to adjust a distance between user's eyes and an ocular lens unit. Moreover, the ocular structure is provided with a concave-convex structure so as to position the outer ring relative to the main body in different positions.

The ocular structure for observation apparatus in accordance with an embodiment of the invention includes a first member, a second member and a main body. The first member includes at least one slot and a plurality of first limiting mechanisms. The second member includes at least one slider extending into the slot and a plurality of second limiting mechanisms. The main body includes an ocular lens unit, wherein the first member and the second member are mounted on the main body. The slider is moved in the slot when the first member and the second member are in relative rotation, and the first limiting mechanisms directly or indirectly match the second limiting mechanisms to position the first member with respect to the second member.

In another embodiment, the first member further includes an outer ring, the second member further includes an inner ring connected to the main body, the outer ring is disposed around the inner ring, the slider is disposed on outer circumferential surfaces of the inner ring, the slot is formed on a wall of the outer ring, and the outer ring is axially moved relative to the main body when the slider is moved in the slot.

In yet another embodiment, each of the first limiting mechanisms includes a plurality of limiting grooves. Each of the second limiting mechanisms includes a plurality of positioning elements. The limiting grooves are formed on inner circumferential surfaces of the outer ring to provide a plurality of positioning spots. The positioning elements are disposed on the outer circumferential surfaces of the inner ring. One of the positioning elements is configured to engage with one of the limiting grooves so as to position the outer ring relative to the main body at one of the positioning spots.

In another embodiment, each of the positioning elements is softer than the outer ring. Each of the positioning elements is softer than the inner ring. Shore hardness of each positioning elements ranges from 50 to 80 degrees.

In yet another embodiment, the second member further includes a plurality of grooves, and the positioning elements are disposed in the grooves.

In another embodiment, the limiting grooves includes a first limiting groove and a second limiting groove, and a distance between the first limiting groove and the second limiting groove is 23 to 28 percent of a height of the first member.

In yet another embodiment, the limiting grooves includes a first limiting groove and a second limiting groove, and a distance between the first limiting groove and the second limiting groove is 15 to 20 percent of a height of the first member.

In another embodiment, each of the first limiting mechanisms includes a plurality of first magnetically attractable elements, each of the second limiting mechanisms includes a plurality of second magnetically attractable elements, the first magnetically attractable elements are disposed on inner circumferential surfaces of the outer ring to provide a plurality of positioning spots, the second magnetically attractable elements are disposed on the outer circumferential surfaces of the inner ring, and one of the second magnetically attractable elements is configured to attract one of the first magnetically attractable elements so as to position the outer ring relative to the main body at one of the positioning spots.

In yet another embodiment, a distance between two of the first magnetically attractable elements is 23 to 28 percent of a height of the first member.

In another embodiment, a distance between two of the first magnetically attractable elements is 15 to 20 percent of a height of the first member.

In yet another embodiment, each of the first limiting mechanisms includes a plurality of positioning elements, each of the second limiting mechanisms includes a plurality of limiting grooves, the limiting grooves are formed on the outer circumferential surfaces of the inner ring to provide a plurality of positioning spots, the positioning elements are disposed on inner circumferential surfaces of the outer ring, and one of the positioning elements is configured to engage with one of the limiting grooves so as to position the outer ring relative to the main body at one of the positioning spots.

In another embodiment, the limiting grooves include a first limiting groove and a second limiting groove, and a distance between the first limiting groove and the second limiting groove is 23 to 28 percent of a height of the first member.

In yet another embodiment, each of the first limiting mechanisms includes a plurality of second magnetically attractable elements, each of the second limiting mechanisms includes a plurality of first magnetically attractable elements, the first magnetically attractable elements are disposed on the outer circumferential surfaces of the inner ring to provide a plurality of positioning spots, the second magnetically attractable elements are disposed on inner circumferential surfaces of the outer ring, and one of the second magnetically attractable elements is configured to attract one of the first magnetically attractable elements so as to position the outer ring relative to the main body at one of the positioning spots.

In another embodiment, a distance between two of the first magnetically attractable elements is 23 to 28 percent of a height of the first member.

In yet another embodiment, the first member further includes an inner ring connected to the main body, the second member further includes an outer ring, the outer ring is disposed around the inner ring, the slider is disposed on inner circumferential surfaces of the outer ring, the slot is formed on a wall of the inner ring, and the outer ring is axially moved relative to the main body when the slider is moved in the slot.

In another embodiment, each of the first limiting mechanisms includes a plurality of limiting grooves, each of the second limiting mechanisms includes a plurality of positioning elements, the limiting grooves are formed on the outer circumferential surfaces of the inner ring to provide a plurality of positioning spots, the positioning elements are disposed on inner circumferential surfaces of the outer ring, and one of the positioning elements is configured to engage with one of the limiting grooves so as to position the outer ring relative to the main body at one of the positioning spots.

In yet another embodiment, each of the first limiting mechanisms includes a plurality of first magnetically attractable elements, each of the second limiting mechanisms includes a plurality of second magnetically attractable elements, the first magnetically attractable elements are disposed on the outer circumferential surfaces of the inner ring to provide a plurality of positioning spots, the second magnetically attractable elements are disposed on inner circumferential surfaces of the outer ring, and one of the second magnetically attractable elements is configured to attract one of the first magnetically attractable elements so as to position the outer ring relative to the main body at one of the positioning spots.

In another embodiment, each of the first limiting mechanisms includes a plurality of positioning elements, each of the second limiting mechanisms includes a plurality of limiting grooves, the limiting grooves are formed on inner circumferential surfaces of the outer ring to provide a plurality of positioning spots, the positioning elements are disposed on the outer circumferential surfaces of the inner ring, and one of the positioning elements is configured to engage with one of the limiting grooves so as to position the outer ring relative to the main body at one of the positioning spots.

In yet another embodiment, each of the first limiting mechanisms includes a plurality of second magnetically attractable elements, each of the second limiting mechanisms includes a plurality of first magnetically attractable elements, the first magnetically attractable elements are disposed on inner circumferential surfaces of the outer ring to provide a plurality of positioning spots, the second magnetically attractable elements are disposed on the outer circumferential surfaces of the inner ring, and one of the second magnetically attractable elements is configured to attract one of the first magnetically attractable elements so as to position the outer ring relative to the main body at one of the positioning spots.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a sectional view of an ocular structure for observation apparatus in accordance with a first embodiment of the invention;

FIG. 2 is a schematic view of the inner ring of FIG. 1;

FIG. 3A is a front view of the positioning element of FIG. 1;

FIG. 3B is a side view of the positioning element of FIG. 1;

FIG. 4 is a perspective view of the outer ring of FIG. 1;

FIG. 5 is a schematic view of the outer ring of FIG. 4;

FIG. 6A is a schematic view of the outer ring positioned in a reference position relative to the inner ring of the FIG. 1;

FIG. 6B is a schematic view of the outer ring positioned in a first position relative to the inner ring of the FIG. 1;

FIG. 6C is a schematic view of the outer ring positioned in a second position relative to the inner ring of the FIG. 1; and

FIG. 6D is a schematic view of the outer ring positioned in a third position relative to the inner ring of the FIG. 1.

### DETAILED DESCRIPTION OF THE INVENTION

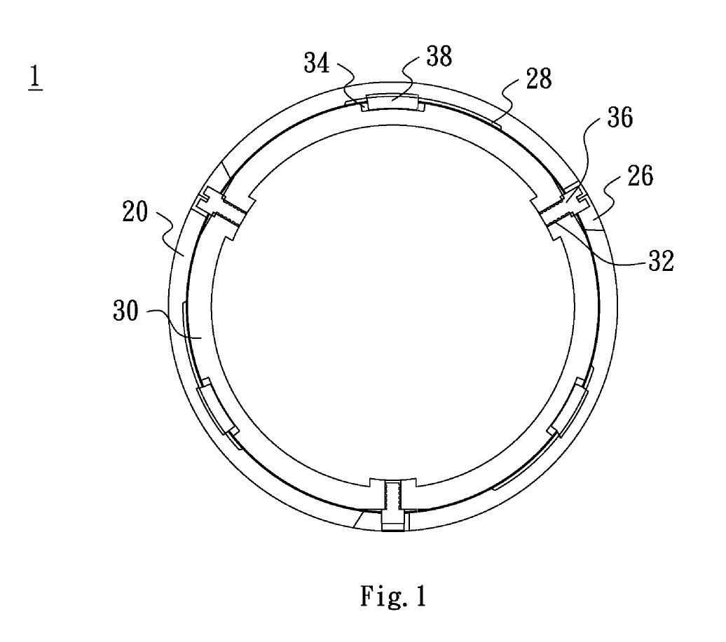

Referring to FIG. 1, an ocular structure 1 in accordance with a first embodiment of the invention includes a main body (not shown), an outer ring 20 and an inner ring 30. The outer ring 20 is configured to move axially relative to the main body and the inner ring 30 and to be selectively positioned in different positions.

In the first embodiment, the main body is the main part of an observation apparatus (e.g. rangefinder, binocular telescope or monocular telescope) and includes an ocular lens unit. The main body has a first end portion and a second end portion which is closer to the ocular lens unit than the first end portion. The inner ring 30 is connected to the second end portion, and the outer ring 20 is rotatably disposed around the inner ring 30.

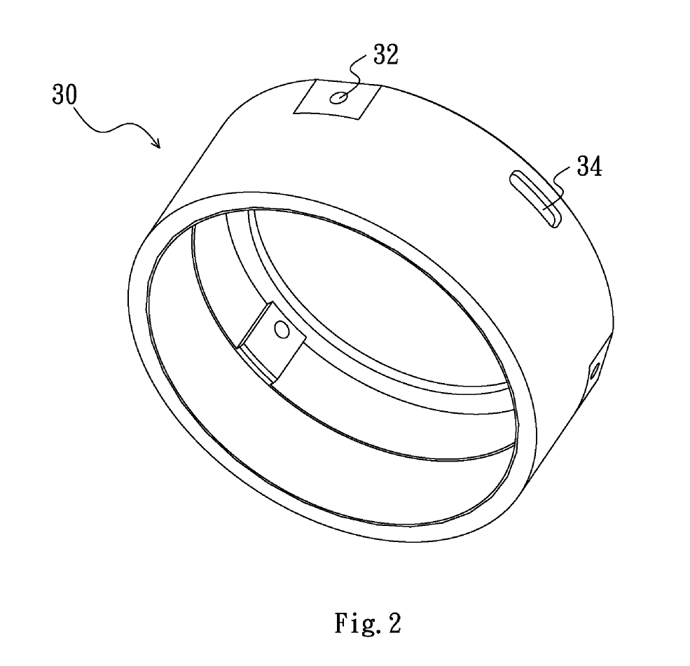

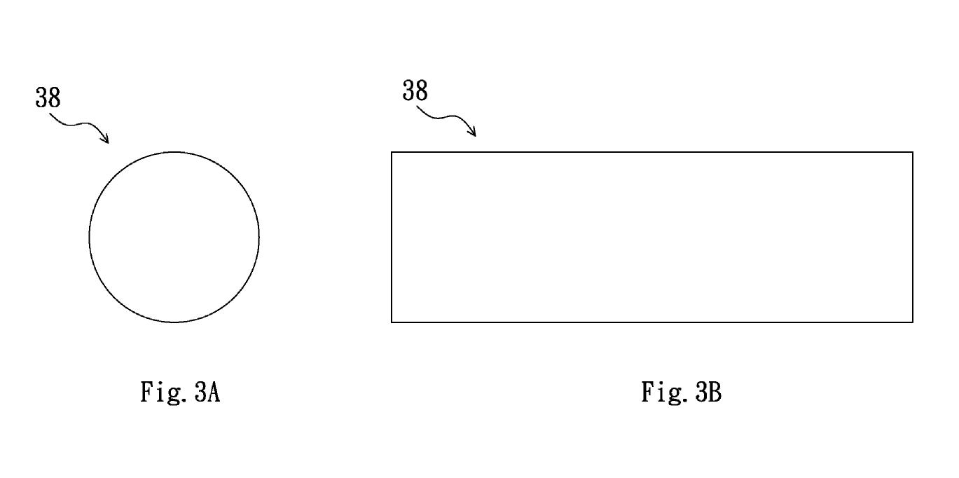

Referring to FIGS. 1 and 2, the inner ring 30 is provided with at least one through hole 32 and at least one groove 34. As shown in FIG. 1, three sliders 36 corresponding to three through holes 32 are equidistantly disposed on outer circumferential surfaces of the inner ring 30. In this embodiment, each of the sliders 36 is a screw and is fastened into each of the through holes 32. Moreover, three positioning elements 38 corresponding to three grooves 34 are also equidistantly disposed on the inner ring 30. Referring to FIGS. 3A and 3B, each of the positioning elements 38 is cylindrical and is disposed in each of the grooves 34.

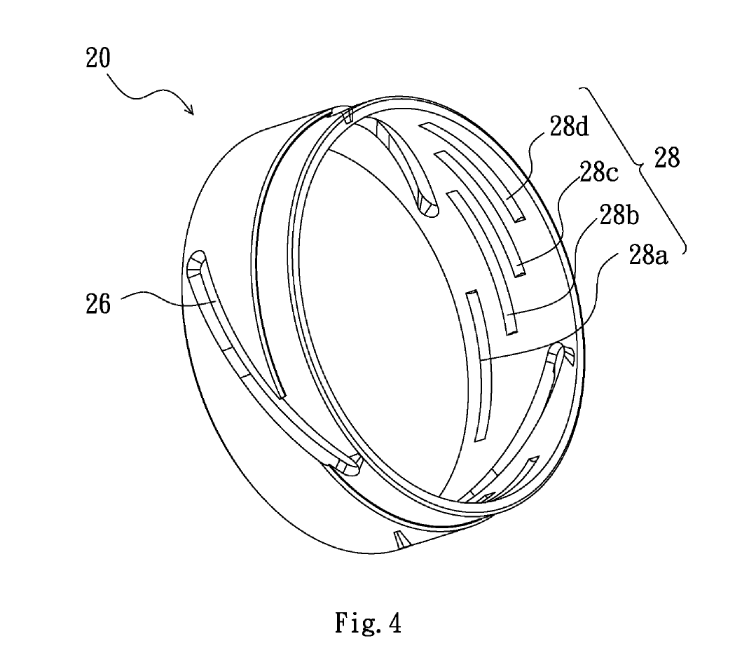

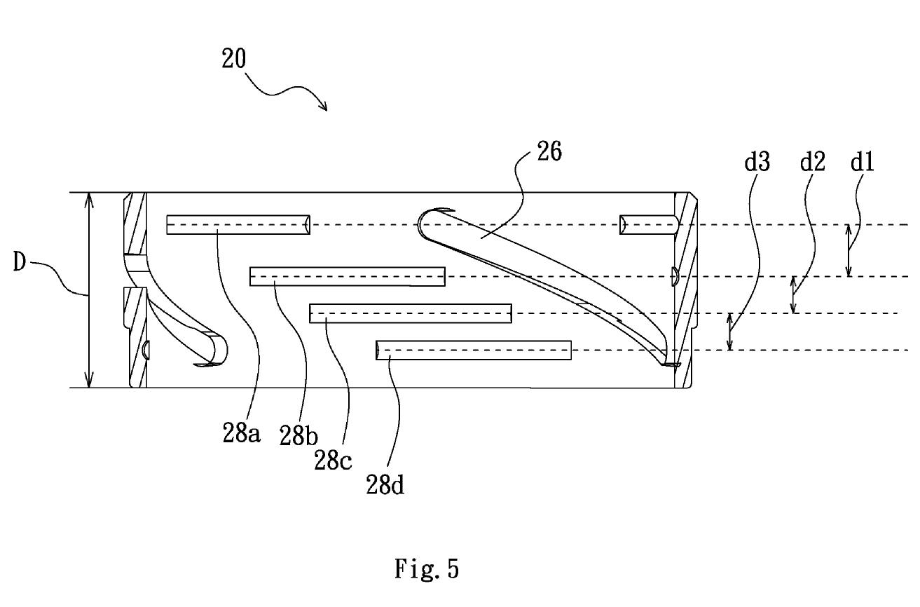

Referring to FIGS. 1, 4 and 5, the outer ring 20 is provided with at least one slot 26 and at least one limiting mechanism 28. As shown in FIG. 1, three slots 26 are equidistantly formed on a wall of the outer ring 20. The sliders 36 are movable in the slots 26 when the outer ring 20 is disposed around the inner ring 30. As shown in FIG. 5, each of the slots 26 is inclined with respect to edges of the outer ring 20 and provides no turning point to slow movement of the sliders 36. Therefore, when the outer ring 20 is rotated, the sliders 36 are moved smoothly in the slots 26, and the outer ring 20 is moved axially relative to the main body and the inner ring 30. Moreover, the limiting mechanism 28 includes at least one limiting groove. In the first embodiment, the limiting mechanism 28 includes four limiting grooves 28a-28d (as shown in FIGS. 1 and 4). The limiting grooves 28a-28d are formed on inner circumferential surfaces of the outer ring 20 as well as correspond to the moving path of the positioning element 38. Thus, the outer ring 20 can be positioned in any of four positions by engaging the positioning element 38 with the corresponding limiting groove 28a, 28b, 28c or 28d when the outer ring 20 is axially moved relative to the inner ring 30. If there are a plurality of limiting mechanisms 28 and corresponding positioning elements 38, then they are equiangularly spaced about a center of the outer ring 20. As shown in FIG. 1, three limiting mechanisms 28 and three corresponding positioning elements 38 are equiangularly spaced at 120 degrees about the center of the outer ring 20. Similarly, if four limiting mechanisms 28 and four corresponding positioning elements 38 are provided, then they will be equiangularly spaced at 90 degrees. The arrangement of more limiting mechanisms and corresponding positioning elements can be inferred by analogy.

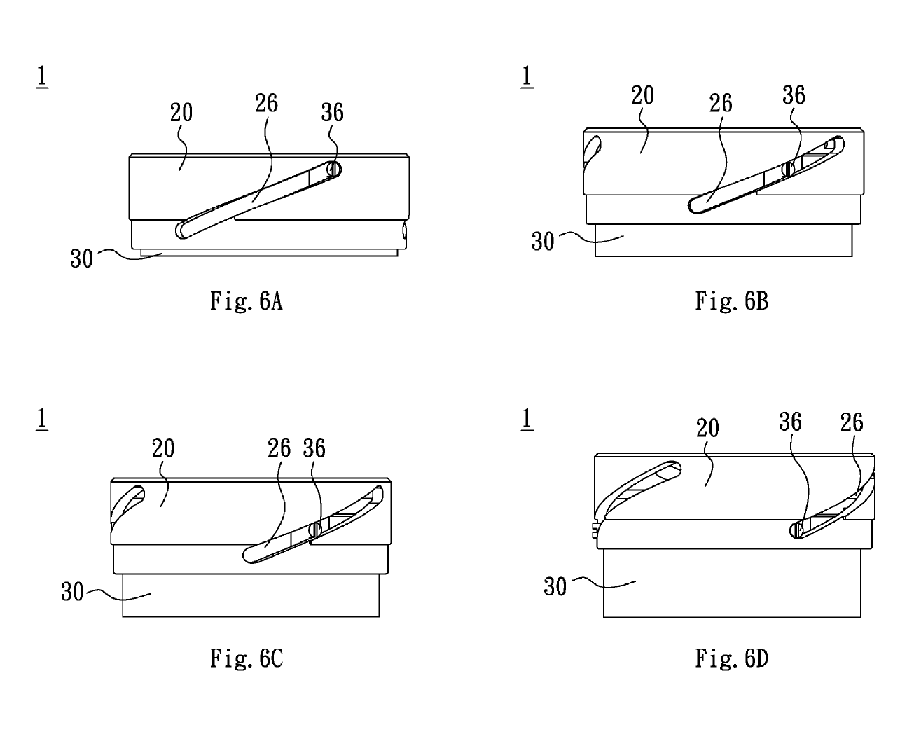

FIGS. 6A to 6D depict that the outer ring 20 is positioned in different predetermined positions relative to the main body or the inner ring 30. As shown in FIG. 6A, the outer ring 20 substantially covers the inner ring 30 when the outer ring 20 is positioned in a reference position. Meanwhile, the positioning elements 38 are engaged with the limiting grooves 28a. Each of the slots 26 includes a first end and a second end, and the sliders 36 are placed against the first ends which are farther from the main body (or are closer to a user's eyes) than the second ends. It is noted that a distance between the user's eyes and the ocular lens unit is shortest when the outer ring 20 is positioned in the reference position. Referring to FIG. 6B, as the outer ring 20 is rotated and axially moved to a first position, the positioning elements 38 are engaged with the limiting grooves 28b, and the sliders 36 are moved in slots 26 in a direction away from the first ends. If the outer ring 20 is further rotated and axially moved to a second position as shown in FIG. 6C, the positioning elements 38 are engaged with the limiting grooves 28c, and the sliders 36 are further moved away from the first ends. When the outer ring 20 is moved axially to a third position as shown in FIG. 6D, the positioning elements 38 are engaged with the limiting grooves 28d, and the sliders 36 are placed against the second ends which are closer to the main body (or are farther from the user's eyes) than the first ends. Meanwhile, the distance between the user's eyes and the ocular lens unit is longest when the outer ring 20 is positioned in the third position. If adjusting the outer ring 20 back to the reference position is desired, then the user can rotate the outer ring 20 in a reverse direction until the sliders 36 are placed against the first ends again (or until the outer ring 20 stops rotating). By way of the sliders 36 and the slots 26, which function similar to mated threads, the outer ring 20 can be axially moved relative to the main body so as to adjust the distance between the user's eyes and the ocular lens unit. Such arrangement can effectively improve the short lifespan problem of the eyecup.

Referring to FIG. 5, it is assumed that a height of the outer ring 20 is D. It is worth noting that a distance d1 between the limiting grooves 28a and the limiting grooves 28b is 23 to 28 percent of the height D, a distance d2 between the limiting grooves 28b and the limiting grooves 28c is 15 to 20 percent of the height D, and a distance d3 between the limiting grooves 28c and the limiting grooves 28d is 15 to 20 percent of the height D. During the operation described above, a time interval of rotation of the outer ring 20 from the reference position to the first position is longer than that from the first position to the second position (or from the second position to the third position) since the distance d1 is longer than the distance d2 (or the distance d3). Thus, the user can be aware of the position of the outer ring 20 relative to the main body and the distance between the user's eyes and the ocular lens unit by the time interval of rotation of the outer ring 20.

Each of the positioning elements 38 is softer than the outer ring 20 and softer than the inner ring 30. In this embodiment, the positioning elements 38 are made of rubber (e.g. Nitrile butadiene rubber or Fluororubber), which has Shore hardness ranges from 50 to 80 degrees. When the outer ring 20 is rotated relative to the inner ring 30 and moves the positioning elements 38 away from any of the limiting grooves 28a-28d (e.g. limiting grooves 28b), the positioning elements 38 are compressed between the inner circumferential surfaces of the outer ring 20 and the grooves 34 since the positioning elements 38 are softer than the outer ring 20 and the inner ring 30. When the outer ring 20 is further rotated and moves the positioning elements 38 to the next limiting grooves (e.g. the limiting grooves 28c), the compressed positioning elements 38 are released and engage with the next limiting grooves (the limiting grooves 28c) and generate a “click” which is a tactile feedback to the user.

In a second embodiment of the invention, an inner ring (not shown) does not include the grooves 34 shown in FIGS. 1 and 2. Also, a plurality of positioning elements are formed integrally with the inner ring and extend towards the outer ring 20 from outer circumferential surfaces of the inner ring. By such arrangement, when the outer ring 20 is rotated relative to the inner ring and moves the positioning elements away from any of the limiting grooves 28a-28d, the positioning elements are compressed between the inner circumferential surfaces of the outer ring 20 and the outer circumferential surfaces of the inner ring. The arrangement of other elements and operation of the second embodiment are similar to those of the first embodiment, and therefore the descriptions thereof are omitted.

Referring to FIGS. 1, 4 and 5, the ocular structure 1 in accordance with the above embodiments of the invention includes three positioning elements 38 and three limiting mechanisms 28, and each of the limiting mechanisms 28 includes four limiting grooves 28a-28d at different heights relative to the outer ring 20. However, it is not necessary for the limiting mechanisms to include the same quantity of limiting grooves (or the positioning elements cooperating with the limiting mechanisms may be changed in number). For example (a third embodiment), the ocular structure includes three limiting mechanisms, wherein a first limiting mechanism includes four limiting grooves, a second limiting mechanism includes three limiting grooves, and a third limiting mechanism includes two limiting grooves. Such arrangement generates different levels of tactile feedback to the user during operation. In detail, when the outer ring is in the first position, the ocular structure has three positioning elements engaged with three limiting grooves. When the outer ring is rotated to move from the first position to the second position, the ocular structure turns to have two positioning elements engaged with two limiting grooves. If the outer ring 20 is further rotated, then the user will be aware that engagement of the inner ring with the outer ring becomes looser than that during the previous rotation. When the outer ring is rotated to move from the second position to the third position, the ocular structure turns to have one positioning element engaged with one limiting groove. It is worth noting that, during the above operation, the positioning element/elements which is/are not engaged with the limiting mechanism/mechanisms is/are compressed between the inner circumferential surfaces of the outer ring and the grooves.

Briefly speaking, the limiting mechanisms can have different numbers of limiting grooves so that the positioning elements cooperating with the limiting mechanisms can be changed in number during operation. That is, the positioning elements engaged with the limiting grooves are different in number when the outer ring is positioned in different positions (e.g. the reference position, the first position, the second position or the third position). The number of the positioning elements cooperating with the limiting grooves affects not only the level of engagement of the inner ring 30 with the outer ring 20, but the force required to rotate the outer ring 30. By such arrangement, both the position of the outer ring 20 relative to the main body and the distance between the user's eyes and the ocular lens unit can be recognized through judging the force required to rotate the outer ring (or tightness during rotation), thereby providing the tactile feedback to the user in different levels and stable rotation of the outer ring. The arrangement of other elements and operation of the third embodiment are similar to those of the above embodiments, and therefore the descriptions thereof are omitted.

It is understood that the locations of the slots 26 and those of the sliders 36 can be exchanged. That is, the slots are formed on a wall of the inner ring, and the sliders are disposed on the inner circumferential surfaces of the outer ring. Such arrangement enables the sliders to move in the slots and enables the outer ring to axially move relative to the main body and therefore is feasible. Further, the locations of the limiting mechanisms 28 and those of the positioning elements 38 can be exchanged. That is, the limiting mechanisms are formed on the outer circumferential surfaces of the inner ring, and the positioning elements are disposed on the outer ring. Such arrangement enables the positioning elements to engage with the limiting mechanisms so as to position the outer ring 20 relative to the main body and therefore is also feasible.

As described above, the positioning elements 38 and the limiting mechanisms 28 are engaged with each other through concave-convex structure. However, besides concave-convex structure, magnetism can be used to position the outer ring 20 relative to the inner ring 30. For example (a fourth embodiment), the positioning elements 38 and the limiting mechanisms 28 are respectively replaced with first magnetic limiting mechanisms (not shown) and second magnetic limiting mechanisms (not shown). Each of the first magnetic limiting mechanisms includes a first magnetically attractable element, and each of the second magnetic limiting mechanisms includes a second magnetically attractable element. More specifically, the first magnetically attractable element is a magnetic element having a first polarity, and the second magnetically attractable element is a magnetic element having a second polarity opposite to the first polarity, or the first magnetically attractable element is a magnetic element, and the second magnetically attractable element is an element (e.g. ferromagnetic element) which can be attracted by the magnetic element. For another example (a fifth embodiment), the first magnetically attractable element protrudes from the outer circumferential surfaces of the inner ring 30, and the inner circumferential surfaces of the outer ring 20 are provided with a hole in which the second magnetically attractable element is disposed. Alternatively, the outer circumferential surfaces of the inner ring 30 are provided with a hole in which the first magnetically attractable element is disposed, and the second magnetically attractable element protrudes from the inner circumferential surfaces of the outer ring 20. For another example (a sixth embodiment), each of the first magnetic limiting mechanisms includes a plurality of first magnetically attractable elements, and each of the second magnetic limiting mechanisms includes a plurality of second magnetically attractable elements. When there are four second magnetically attractable elements, distances therebetween are similar to the distances d1, d2 and d3 as shown in FIG. 5. The arrangement of other elements and operation of the fourth, fifth and sixth embodiments are similar to those of the above embodiments, and therefore the descriptions thereof are omitted.

What is claimed is:

1. An ocular structure for observation apparatus, comprising:
a first member comprising at least one slot and a plurality of first limiting mechanisms;
a second member which comprises at least one slider extending into the slot and a plurality of second limiting mechanisms; and
a main body comprising an ocular lens unit, wherein the first member and the second member are mounted on the main body;
wherein the slider is moved in the slot when the first member and the second member are in relative rotation, and the first limiting mechanisms directly or indirectly match the second limiting mechanisms to position the first member with respect to the second member.

2. The ocular structure for observation apparatus as claimed in claim 1, wherein the first member further comprises an outer ring, the second member further comprises an inner ring connected to the main body, and the outer ring is disposed around the inner ring.

3. The ocular structure for observation apparatus as claimed in claim 2, wherein the slider is disposed on outer circumferential surfaces of the inner ring, the slot is formed on a wall of the outer ring, and the outer ring is axially moved relative to the main body when the slider is moved in the slot.

4. The ocular structure for observation apparatus as claimed in claim 2, wherein each of the first limiting mechanisms comprises a plurality of limiting grooves or a plurality of first magnetically attractable elements, each of the second limiting mechanisms comprises a plurality of positioning elements or a plurality of second magnetically attractable elements, the limiting grooves or the first magnetically attractable elements are formed on inner circumferential surfaces of the outer ring to provide a plurality of positioning spots, the positioning elements or the second magnetically attractable elements are disposed on the outer circumferential surfaces of the inner ring, and one of the positioning elements or the second magnetically attractable elements is configured to engage with one of the limiting grooves or the first magnetically attractable elements so as to position the outer ring relative to the main body at one of the positioning spots.

5. The ocular structure for observation apparatus as claimed in claim 2, wherein each of the first limiting mechanisms comprises a plurality of positioning elements or a plurality of second magnetically attractable elements, each of the second limiting mechanisms comprises a plurality of limiting grooves or a plurality of first magnetically attractable elements, the limiting grooves or the first magnetically attractable elements are formed on the outer circumferential surfaces of the inner ring to provide a plurality of positioning spots, the positioning elements or the second magnetically attractable elements are disposed on inner circumferential surfaces of the outer ring, and one of the positioning elements or the second magnetically attractable elements is configured to engage with one of the limiting grooves or the first magnetically attractable elements so as to position the outer ring relative to the main body at one of the positioning spots.

6. The ocular structure for observation apparatus as claimed in claim 4, wherein each of the positioning elements is softer than the outer ring, each of the positioning elements is softer than the inner ring, and Shore hardness of each positioning elements ranges from 50 to 80 degrees.

7. The ocular structure for observation apparatus as claimed in claim 4, wherein the second member further comprises a plurality of grooves, and the positioning elements are disposed in the grooves.

8. The ocular structure for observation apparatus as claimed in claim 4, wherein the limiting grooves comprises a first limiting groove and a second limiting groove, and a distance between the first limiting groove and the second limiting groove is 23 to 28 percent of a height of the first member;
wherein a distance between two of the first magnetically attractable elements is 23 to 28 percent of a height of the first member.

9. The ocular structure for observation apparatus as claimed in claim 4, wherein the limiting grooves comprises a first limiting groove and a second limiting groove, and a distance between the first limiting groove and the second limiting groove is 15 to 20 percent of a height of the first member;
wherein a distance between two of the first magnetically attractable elements is 15 to 20 percent of a height of the first member.

10. The ocular structure for observation apparatus as claimed in claim 1, wherein the first member further comprises an inner ring connected to the main body, the second member further comprises an outer ring, and the outer ring is disposed around the inner ring.

11. The ocular structure for observation apparatus as claimed in claim 10, wherein the slider is disposed on inner circumferential surfaces of the outer ring, the slot is formed on a wall of the inner ring, and the outer ring is axially moved relative to the main body when the slider is moved in the slot.

12. The ocular structure for observation apparatus as claimed in claim 10, wherein each of the first limiting mechanisms comprises a plurality of limiting grooves or a plurality of first magnetically attractable elements, each of the second limiting mechanisms comprises a plurality of positioning elements or a plurality of second magnetically attractable elements, the limiting grooves or the first magnetically attractable elements are disposed on inner circumferential surfaces of the outer ring to provide a plurality of positioning spots, the positioning elements or the second magnetically attractable elements are disposed on the outer circumferential surfaces of the inner ring, and one of the positioning elements or the second magnetically attractable elements is configured to attract one of the limiting grooves or the first magnetically attractable elements so as to position the outer ring relative to the main body at one of the positioning spots.

13. The ocular structure for observation apparatus as claimed in claim 10, wherein each of the first limiting mechanisms comprises a plurality of positioning elements or a plurality of second magnetically attractable elements, each of the second limiting mechanisms comprises a plurality of limiting grooves or a plurality of first magnetically attractable elements, the limiting grooves or the first magnetically attractable elements are formed on the outer circumferential surfaces of the inner ring to provide a plurality of positioning spots, the positioning elements or the second magnetically attractable elements are disposed on inner circumferential surfaces of the outer ring, and one of the positioning elements or the second magnetically attractable elements is configured to engage with one of the limiting grooves or the first magnetically attractable elements so as to position the outer ring relative to the main body at one of the positioning spots.

14. The ocular structure for observation apparatus as claimed in claim 13, wherein the limiting grooves comprises a first limiting groove and a second limiting groove, and a distance between the first limiting groove and the second limiting groove is 23 to 28 percent of a height of the first member;
wherein a distance between two of the first magnetically attractable elements is 23 to 28 percent of a height of the first member.

15. The ocular structure for observation apparatus as claimed in claim 2, wherein each of the first limiting mechanisms comprises a plurality of limiting grooves, each of the second limiting mechanisms comprises a plurality of positioning elements, the limiting grooves are formed on inner circumferential surfaces of the outer ring to provide a plurality of positioning spots, the positioning elements are disposed on the outer circumferential surfaces of the inner ring, and one of the positioning elements is configured to engage with one of the limiting grooves so as to position the outer ring relative to the main body at one of the positioning spots.

16. The ocular structure for observation apparatus as claimed in claim 15, wherein the limiting grooves comprises a first limiting groove and a second limiting groove, and a distance between the first limiting groove and the second limiting groove is 23 to 28 percent of a height of the first member.

17. The ocular structure for observation apparatus as claimed in claim 10, wherein each of the first limiting mechanisms comprises a plurality of first magnetically attractable elements, each of the second limiting mechanisms comprises a plurality of second magnetically attractable elements, the first magnetically attractable elements are disposed on the outer circumferential surfaces of the inner ring to provide a plurality of positioning spots, the second magnetically attractable elements are disposed on inner circumferential surfaces of the outer ring, and one of the second magnetically attractable elements is configured to attract one of the first magnetically attractable elements so as to position the outer ring relative to the main body at one of the positioning spots.

18. The ocular structure for observation apparatus as claimed in claim 10, wherein each of the first limiting mechanisms comprises a plurality of positioning elements, each of the second limiting mechanisms comprises a plurality of limiting grooves, the limiting grooves are formed on the outer circumferential surfaces of the inner ring to provide a plurality of positioning spots, the positioning elements are disposed on inner circumferential surfaces of the outer ring, and one of the positioning elements is configured to engage with one of the limiting grooves so as to position the outer ring relative to the main body at one of the positioning spots.

19. The ocular structure for observation apparatus as claimed in claim 18, wherein the limiting grooves comprise a first limiting groove and a second limiting groove, and a distance between the first limiting groove and the second limiting groove is 23 to 28 percent of a height of the first member.

20. The ocular structure for observation apparatus as claimed in claim 10, wherein each of the first limiting mechanisms comprises a plurality of second magnetically attractable elements, each of the second limiting mechanisms comprises a plurality of first magnetically attractable elements, the first magnetically attractable elements are formed on the outer circumferential surfaces of the inner ring to provide a plurality of positioning spots, the second magnetically attractable elements are disposed on inner circumferential surfaces of the outer ring, and one of the second magnetically attractable elements is configured to engage with one of the first magnetically attractable elements so as to position the outer ring relative to the main body at one of the positioning spots.
